(19) United States
(12) Patent Application Publication
(10) Pub. No.: US 2005/0125736 A1
(43) Pub. Date: Jun. 9, 2005

(54) Personalized desktop workspace icon organizer

(75) Inventors: Richard C. Ferri, Ulster Park, NY (US); Moon Ju Kim, Wappingers Fall, NY (US); Jonathan Mark Wagner, Round Rock, TX (US); William George White, Poughkeepsie, NY (US)

Correspondence Address: IBM CORPORATION (RUS), C/O SIEGESMUND & ASSOCIATES, 4627 NORTH CENTRAL EXPRESSWAY, SUITE 2000, DALLAS, TX, 75206, US

(73) Assignee: International Business Machines Corporation, Armonk, NY (US)

(21) Appl. No.: 10/730,957

(22) Filed: Dec. 9, 2003

(51) Int. Cl. G06F 3/00

(52) U.S. Cl. 715/747; 715/744; 715/745; 715/746; 715/765; 715/826; 715/866; 715/764; 715/766

(57) ABSTRACT

A method of organizing icons on a desktop into groups and displaying the icon groups in segments on the desktop. The present invention comprises a Configuration Program (CP), an Icon Grouping Program (IGP), and an Icon Organization Program (IOP). The CP allows a user to define at least one segment on the desktop. The user defines the segment location, the segment size, the types of icons associated with the segment, the icon organization within the segment, and whether the segment covers the desktop wallpaper. The IGP analyzes the icons and places the icons into the proper segments based on the type of application associated with the icon. The IOP organizes the icons within each segment using the icon organization specified by the user in the CP. The IOP also organizes new icons that are added to the desktop. The present invention may also be applied to a web portal.

### FIELD OF THE INVENTION

The present invention relates generally to organizational methods for computer desktops and specifically to a computer program for organizing a plurality of icons into groups on a computer desktop.

### BACKGROUND OF THE INVENTION

As the storage and processing capacity of computer workstations increases, a single workstation is able to store and run an increased number of computer applications. Moreover, as the applications become more complex, each application may require a plurality of other concurrently running applications in order to achieve the desired result. For example, MICROSOFT® INTERNET EXPLORER® can be used to view web pages encoded in HTML; however, if a web page contains an ADOBE® .pdf document, then the computer must concurrently run ADOBE READER® or ADOBE ACROBAT® in order to view the web page. Web pages containing ADOBE® .pdf documents are a common occurrence when surfing the Internet. Therefore, when the user installs INTERNET EXPLORER® on his computer, the installation disk automatically installs ADOBE READER® onto the user's computer as well. The automatic installation of ADOBE READER® is beneficial to the user because the user will be able to view web pages containing .pdf documents without having to manually install ADOBE READER® at a later time.

One of the features associated with automatic installation of software is that the installation process places icons on the computer desktop. The icons allow the user to run the application from the desktop rather than running the application from the program selection menu (i.e. the START box in WINDOWS®). If the software program automatically installs additional programs such as ADOBE READER®, the automatic installation places a plurality of icons on the computer desktop, one for each installed application. The automatic installation process may also install icons on the desktop for documentation and other items of interest. The result is a multiplicity of icons on a user's computer desktop. The current method for placing the multiplicity of icons on the computer desktop is to place the new icons in a vertical row under the previously installed icons. However, the prior art method of icon placement is not preferable because the order of the icons on the desktop appears to be random to the user. What is needed in the art is a method for organizing the icons on a computer desktop. The organizational method would be especially useful to the user if the user were able to specify the criteria for icon organization. The prior art does not contain a method that allows the user to specify the criteria for icon organization. Therefore, a need exists in the art for a method for organizing icons on a computer desktop in which the user is able to define the criteria for organizing the icons.

Another problem associated with a multiplicity of icons is that the number of icons may actually exceed the desktop space. When this occurs, the icons are placed on top of other icons. Placing icons on top of other icons is not preferable because the user is unable to run an application using an icon when the icon is covered by another icon. Therefore, a need exists for a method of arranging icons on a computer desktop in which the icons do not cover one another.

With the increased usage of digital cameras, it is becoming more common for computer users to use their computer desktop as a place for photographs. In other words, computer users place pictures of family, friends, and/or travel on their computer desktop. One of the other problems with placing icons on a computer desktop is that the icons cover the user's wallpaper. The user is then faced with the choice of deleting the icons to see the picture better, or leaving the icons on the desktop and obscuring the picture. Therefore, a need exists in the art for a method of placing icons on a computer desktop in which the icons do not cover the user's wallpaper.

The prior art has previously attempted to address the needs identified above. For example, U.S. Pat. No. 5,784,061 (the '061 patent) entitled “Method and Apparatus for Collapsing and Expanding Selected Regions on a Workspace on a Computer Controlled Display System” discloses a method for maximizing desktop space by representing a plurality of icons as a single icon. The single icon in the '061 patent can be opened to reveal the plurality of collapsed icons. However, the method in the '061 patent requires the user to undertake the additional step of opening the single icon in order to run the application using one of the collapsed icons. Therefore, a need still exists for organizing icons in which the user does not have to open a plurality of icons in order to run an application.

U.S. Pat. No. 5,977,973 (the '973 patent) entitled “Window Linking” discloses a method for linking a plurality of windows together in the WINDOWS® operating environment. The window linking method allows the user to reduce the number of open windows, thereby reducing the cluttered appearance of the desktop. However, the linked windows still obscure the user's wallpaper to the same extent as the unlinked windows. Therefore, a need exists in the art for a method to reduce clutter on a desktop without obscuring the user's wallpaper.

U.S. Pat. No. 6,426,761 (the '761 patent) entitled “Information Presentation System for a Graphical User Interface” discloses a method for arranging icons in a fractal pattern. The method in the '761 patent allows the user to manipulate the icon size such that the user never runs out of desktop space. However, the icons in the '761 patent, while reduced in size, still obscure the user's wallpaper. Therefore, a need still exists in the art for a method of organizing icons on a desktop in which the user's wallpaper is not obscured.

Consequently, a need exists in the art for an improved method and system for organizing icons on a computer desktop. The need extends to an improved organizational method in which the user can define icon groups and in which the icons are automatically placed into the icon groups based on the application associated with an icon. Finally, the need extends to an organizational method in which the icons do not obscure the user's wallpaper on the computer desktop.

### SUMMARY OF THE INVENTION

The present invention, which meets the needs stated above, is a method of organizing icons on a desktop into groups and displaying the icon groups in segments on the desktop. The software embodiment of the present invention comprises a Configuration Program (CP), an Icon Grouping Program (IGP), and an Icon Organization Program (IOP). The CP allows a user to define at least one segment on the desktop. The user defines the segment location, the segment size, the types of icons associated with the segment, the icon organization within the segment, and whether the segment covers the desktop wallpaper. The IGP analyzes the icons and places the icons into the proper segments based on the type of application associated with the icon. The IOP organizes the icons within each segment using the icon organization specified by the user in the CP. The IOP also organizes new icons that are added to the desktop. The present invention may also be applied to a web portal or home web page.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a computer network used to implement the present invention;

FIG. 2 is an illustration of a computer, including a memory and a processor, associated with the present invention;

FIG. 3 is an illustration of the logic of the Configuration Program (CP) of the present invention;

FIG. 4 is an illustration of the logic of the Icon Grouping Program (IGP) of the present invention;

FIG. 5 is an illustration of the logic of the Icon Organization Program (IOP) of the present invention;

FIG. 6 is an illustration of the Graphical User Interface (GUI) displaying the configuration window of the present invention; and

FIG. 7 is an illustration of the desktop of the present invention.

### DETAILED DESCRIPTION OF THE PREFERRED EMBODIMENT

As used herein, the term “analyze” shall mean to examine the code of an icon and determine the type of application associated with the icon.

As used herein, the term “application” shall mean a computer program designed to assist in the performance of a specific task or function, such as by way of example an not limited to, word processing, accounting, or inventory management.

As used herein, the term “classify” shall mean to group a plurality of icons together into an icon group using the types of applications associated with the icons.

As used herein, the term “computer” shall mean a machine having a processor, a memory, and an operating system, capable of interaction with a user or other computer, and shall include without limitation desktop computers, notebook computers, personal digital assistants (PDAs), servers, handheld computers, and similar devices.

As used herein, the term “desktop” shall mean an on-screen work area that uses icons and menus to access files.

As used herein, the term “icon” shall mean an image displayed on a computer desktop which runs an application when clicked.

As used herein, the term “icon group” shall mean a plurality of icons with common attributes, which are placed into a segment.

As used herein, the term “organize” shall mean to arrange a plurality of icons in a specific manner.

As used herein, the term “segment” shall mean a portion of a desktop which contains an icon group.

As used herein, the term “wallpaper” shall mean a pattern or picture displayed on the desktop, which can be chosen by a user.

FIG. 1 is an illustration of computer network 90 associated with the present invention. Computer network 90 comprises local computer 95 electrically coupled to network 96. Local computer 95 is electrically coupled to remote computer 94 and remote computer 93 via network 96. Local computer 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of a possible operating network containing the present invention and is not meant as an architectural limitation.

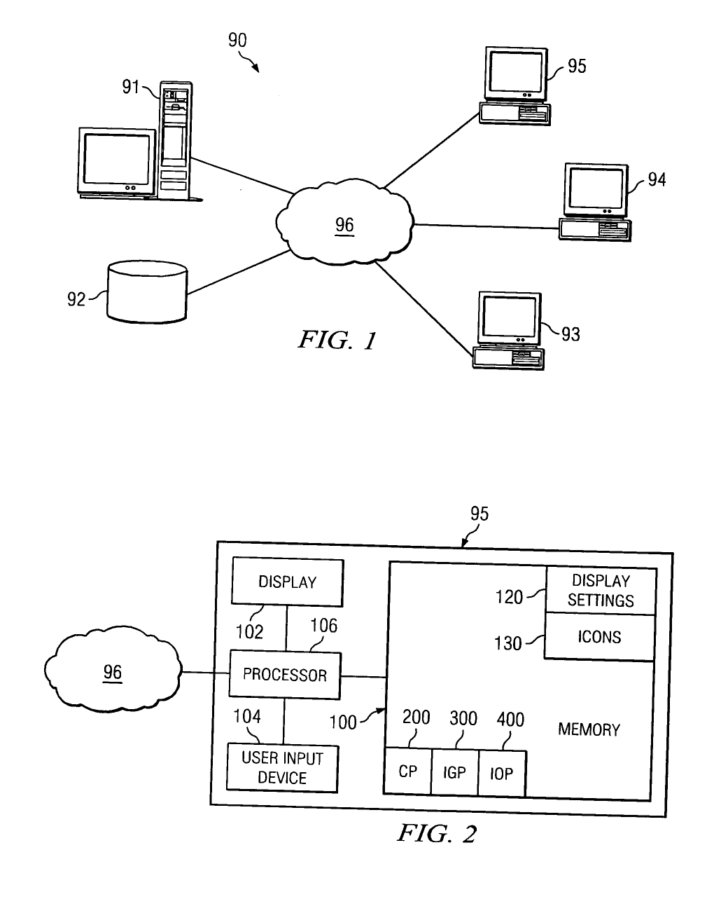

The internal configuration of a computer, including connection and orientation of the processor, memory, and input/output devices, is well known in the art. The present invention is a methodology that can be embodied in a computer program. Referring to FIG. 2, the methodology of the present invention is implemented on software by Configuration Program (CP) 200, Icon Grouping Program (IGP) 300, and Icon Organization Program (IOP) 400. CP 200, IGP 300, and IOP 400 described herein can be stored within the memory of any computer depicted in FIG. 1. Alternatively, CP 200, IGP 300, and/or IOP 400 can be stored in an external storage device such as a removable disk, a CD-ROM, or a USB storage device. Memory 100 is illustrative of the memory within one of the computers of FIG. 1. Memory 100 also contains display settings 120 and icons 130. The present invention may interface with display settings 120 and icons 130 through memory 100. As part of the present invention, the memory 100 can be configured with CP 200, IGP 300, and/or IOP 400. Processor 106 can execute the instructions contained in CP 200, IGP 300, and/or IOP 400. Processor 106 is also able to display data on display 102 and accept user input on user input device 104. Processor 106, user input device 104, display 102, and memory 100 are part of a computer such as local computer 95 in FIG. 1. Processor 106 can communicate with other computers via network 96.

In alternative embodiments, CP 200, IGP 300, and/or IOP 400 can be stored in the memory of other computers. Storing CP 200, IGP 300, and/or IOP 400 in the memory of other computers allows the processor workload to be distributed across a plurality of processors instead of a single processor. Further configurations of CP 200, IGP 300, and/or IOP 400 across various memories are known by persons of ordinary skill in the art. The present invention may be a method, a stand alone computer program, or a plug-in to an existing computer program. Persons of ordinary skill in the art are aware of how to configure computer programs, such as those described herein, to plug into an existing computer program.

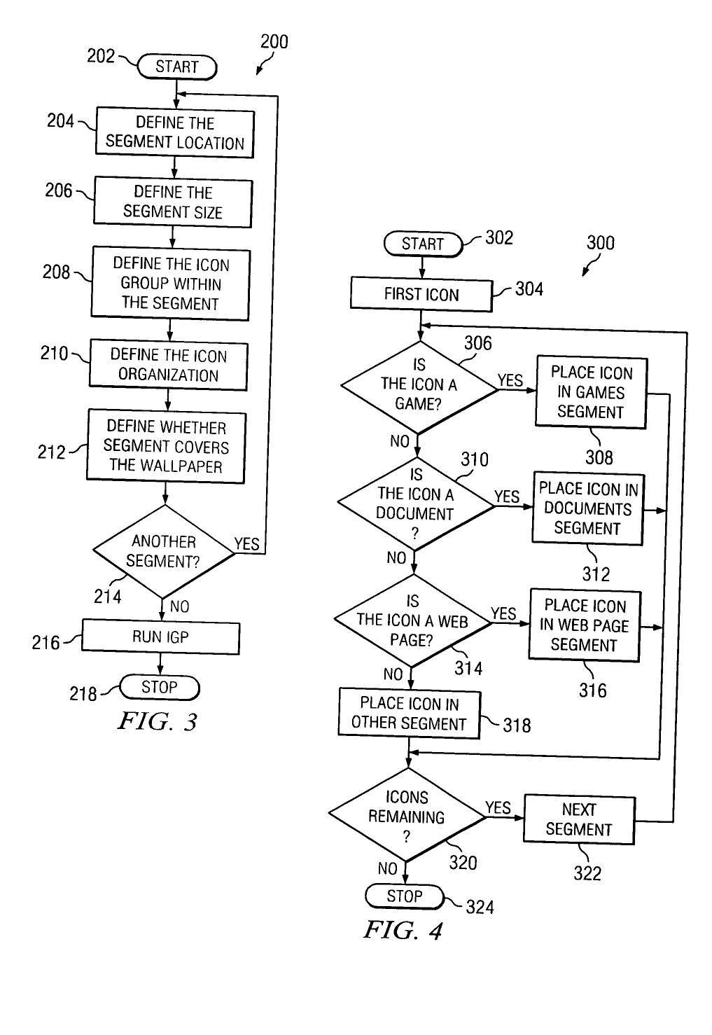

Turning to FIG. 3, the logic of Configuration Program (CP) 200 is illustrated. CP 200 is a computer program that allows a user to define a segment on the desktop by using a dialogue box or similar user input feature. CP 200 starts (202) when CP 200 is invoked by the user. The user then defines the location of the segment (204). The segment may be located at the top, the bottom, the left side, the right side, or in the center of the desktop. Alternatively, the user may define the location of the segment using the (x,y) coordinates of the Cartesian coordinate system for the desktop. The user then defines the size of the segment (206). The segment size may be defined as a percentage of the screen size or as a number a pixels. Alternatively, the user may define the length and width of the segment using the (x,y) coordinates of the Cartesian coordinate system for the desktop. The user then defines the icon group within the segment (208). Possible icon groups within a segment are documents, games, web pages, development tools, and other. Persons of ordinary skill in the art are aware of other icon groups for desktop icons.

The user then defines the icon organization (210). The icons may be organized in one of several manners. For example, one manner of organizing icons is to shrink all of the icons down to the smallest possible size that the icon source code supports and place the shrunken icons as close together as possible within the segment. When referring to icon size herein, the reference is to the visual dimensions of the icon on the Graphical User Interface (GUI) rather than the amount of memory used to store the icon. Another manner for organizing icons is to adjust the size of the icons to fill the segment. A third manner for organizing icons is to place the icons in the segment at their normal size, but if all of the icons do not fit into the segment, reduce the icons in size until the icons fit into the segment. A fourth manner for organizing icons is to place the icons in the segment at their normal size, and to add scroll bars to the segment if there is insufficient room in the segment for the icons. Persons of ordinary skill in the art are aware of other methods for organizing icons within a segment.

The user then defines whether the segment covers the wallpaper (212). The wallpaper is defined in the display settings, which may be like display settings 120 in FIG. 2. The wallpaper may be a .bmp, .jpg, or .gif file. Persons of ordinary skill in the art are aware of other types of files that can be used for desktop wallpaper. If the segment covers the wallpaper, the icons are placed directly on top of the wallpaper. If the segment does not cover the wallpaper, the wallpaper is reduced in size so that the segment does not cover the wallpaper. CP 200 then determines if the user desires to create another segment (214). If the user desires to create another segment, then CP 200 returns to step 204. If the user does not desire to create another segment, CP 200 runs IGP 300 (216) and ends (218).

Turning to FIG. 4, the logic of Icon Grouping Program (IGP) 300 is illustrated. IGP 300 is a program that classifies the icons into groups. The icons may be like icons 130 in FIG. 2. The specific steps of IGP 300 will depend on the types of icon groups defined by the user. The steps illustrated in FIG. 4 are for the following icon groups: games, documents, web pages, and other. IGP 300 starts (302) when invoked by CP 200. Alternatively, IGP 300 can start whenever a new icon is added to the desktop. IGP 300 analyzes the first icon (304). In analyzing the icon, IGP 200 determines what type of application the icon is associated with. For example, if the icon is associated with a MICROSOFT® INTERNET EXPLORER® or NETSCAPE® NAVIGATOR®, then the icon is a web page. If the icon is associated with MICROSOFT®WORD® or COREL® WORDPERFECT®, then the icon is a document. Persons of ordinary skill in the art are aware of how to determine what type of application an icon is associated with.

IGP 300 then determines whether the icon is a game icon (306). If the icon is a game icon, then IGP 300 places the icon in the games segment (308) and proceeds to step 320. If the icon is not a game icon, then IGP 300 determines if the icon is a document icon (310). If the icon is a document icon, then IGP 300 places the icon in the documents segment (312) and proceeds to step 320. If the icon is not a document icon, then IGP 300 determines if the icon is a webpage icon (314). If the icon is a webpage icon, then IGP 300 places the icon in the webpages segment (316) and proceeds to step 320. If the icon is not a webpage icon, then IGP 300 places the icon in the other segment (318). IGP 300 then determines if there are icons remaining (320). If there are icons remaining, IGP 300 analyzes the next segment (322) and returns to step 306. If there are not any icons remaining, then IGP 300 ends (324).

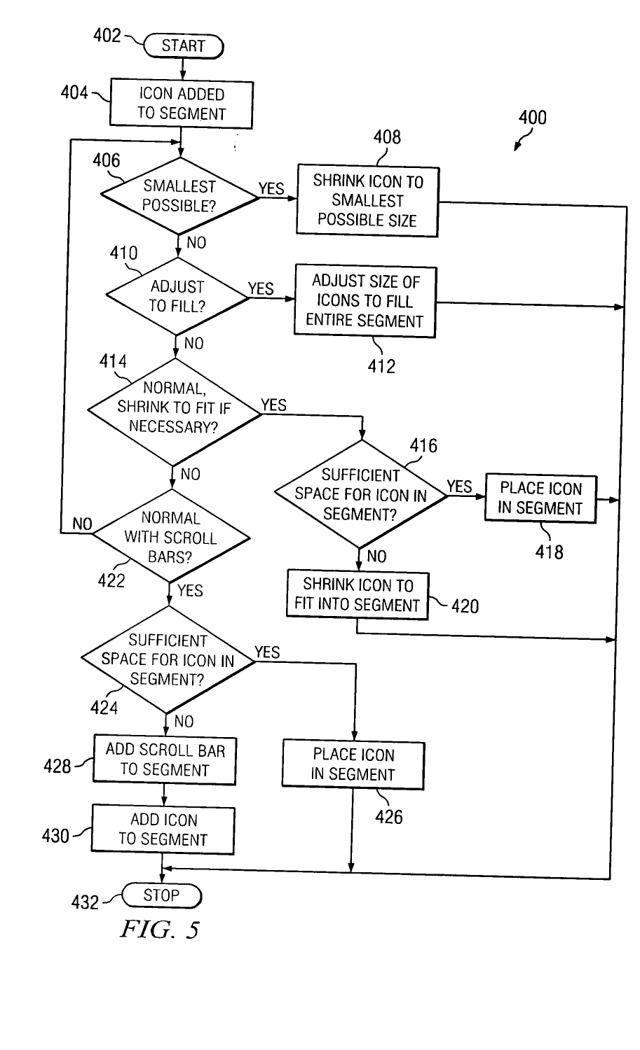

Turning to FIG. 5, the logic of the Icon Organization Program (IOP) 400 is illustrated. IOP 400 is a program that organizes the icons within the segments on the desktop. The icons may be added during the initial configuration of the present invention by CP 200. The icons may also be added at a later time when the user installs additional software programs on the computer associated with the present invention. Persons of ordinary skill in the art are aware of other times when icons are added to a segment. IOP 400 starts (402) whenever an icon is added to a segment (404). IOP 400 then determines if the icon organization defined in CP 200 is the smallest possible icons (406). If the icon organization is the smallest possible icons, then IOP 400 shrinks the icons to their smallest possible size allowed by the icon source code and reduces the space between icons until all of the icons fit into the segment (408). IOP 400 then ends (432). If at step 406, the icon organization is not the smallest possible icons, IOP 400 determines if the icon organization defined in CP 200 is to adjust the icons to fill the segment (410). If the icon organization is to adjust the icons to fill, IOP 400 adjusts the icon size so that the icons fill the entire segment (412) and ends (432).

If at step 410, the icon organization is not adjust to fill, then IOP 400 determines if the icon organization defined in CP 200 is normal size but shrink to fit if necessary (414). If the icon organization is normal size but shrink to fit if necessary, then IOP 400 determines if there is sufficient space in the segment for the present icon (416). If there is sufficient space in the segment for the present icon, IOP 400 places the icon in the segment at normal size (418) and ends (432). If there is insufficient space in the segment for the present icon, IOP 400 shrinks the icons in the segment until all of the icons in the segment, including the present icon, fit into the segment (420). IOP 400 then ends (432).

If at step 414, the icon organization is not normal size, but shrink to fit if necessary, IOP 400 determines if the icon organization defined in step 422 is normal sized icons with scroll bars if necessary (422). If the icon organization in step 422 is not normal sized icons with scroll bars if necessary, then IOP 400 returns to step 406. If the icon organization is normal sized icons with scroll bars if necessary, then IOP 400 determines if there is sufficient space in the segment for the present icon (424). If there is sufficient space in the segment for the present icon, IOP 400 places the icon in the segment at normal size (426) and ends (432). If there is insufficient space in the segment for the present icon, IOP 400 adds a scroll bar to the segment (428) and adds the present icon to the segment (430). Persons of ordinary skill in the art will appreciate that only some of the icons in a segment will be visible if a segment contains a scroll bar. IOP 400 then ends (432).

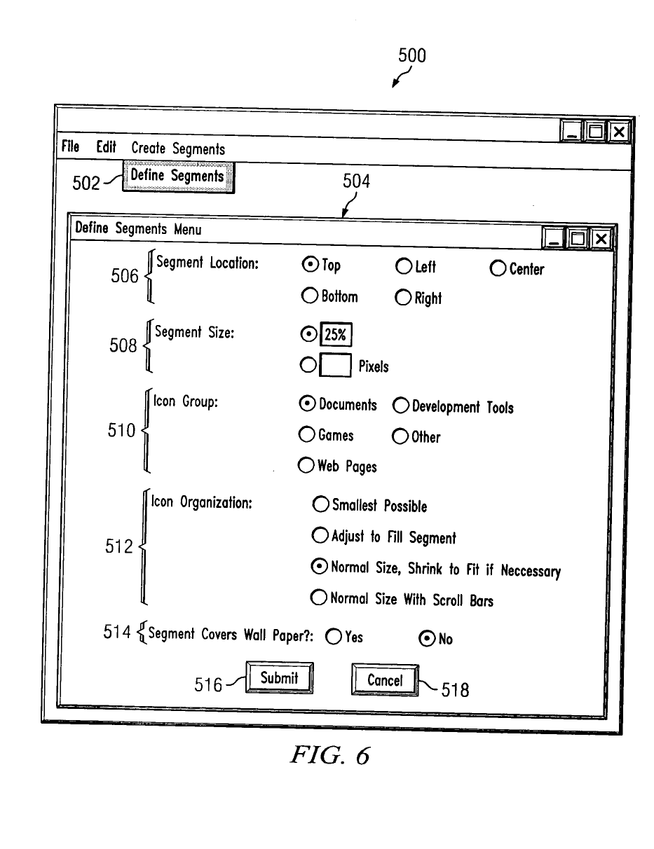

Turning to FIG. 6, Graphical User Interface (GUI) 500 is illustrated. GUI 500 depicts define segments menu 504, which may be invoked by clicking define segment menu selection 502. Define segments menu 504 contains a plurality of segment location choices 506, which may be top, bottom, left, right, or center. Define segments menu 504 also contains a plurality of segment size choices 508, which may be defined as a percentage of the screen or a specific number of pixels. Define segments menu 504 also contains a plurality of icon categories 510, which may be documents, games, web pages, development tools, or other. Define segments menu 504 also contains a plurality of icon organizational options 512, which may be smallest possible icons, adjust icons size to fill segment, normal size but shrink icon size to fit into segment if necessary, and normal size with scroll bars if necessary. Define segments menu 504 also contains an area which the user may define to have the segment cover the wallpaper 514. The user may submit the selections made using submit button 516 or cancel the selections using cancel button 518.

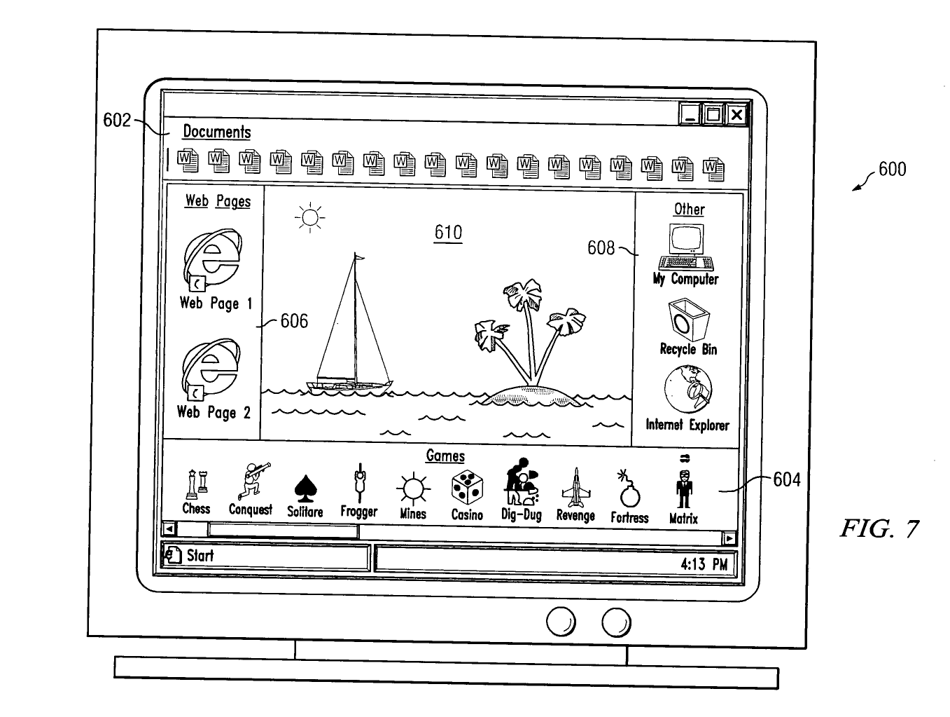

Turning to FIG. 7, desktop 600 of the present invention is illustrated. Desktop 600 comprises four segments: top segment 602, bottom segment 604, left segment 606, and right segment 608. Top segment 602 contains icons which are organized in the smallest possible icon organization. Bottom segment 604 contains icons that are organized in the normal sized icons with scroll bar. Left segment 606 contains icons that are expanded to fill the segment. Right segment 608 contains icons that are shrunken to fit the segment. Desktop 600 also contains wallpaper 610. The four depicted segments do not cover wallpaper 610.

In an alterative embodiment, the present invention can be applied to a web portal or home web page. The web portal is a web page that is similar to the user's computer desktop. Web portals are fully configurable by the user and allow the user to navigate the Internet with greater ease. Persons of ordinary skill in the art are aware of how to configure the HTML of a web portal to accept the novel features of the present invention. In another alternative embodiment, the user can modify the size of the segment by dragging the cursor over the segment wall. Resizing by dragging a cursor over the segment wall is similar to resizing a window by dragging the cursor over one of the sides of the window.

With respect to the above description, it is to be realized that the optimum dimensional relationships for the parts of the invention, to include variations in size, materials, shape, form, function, manner of operation, assembly, and use are deemed readily apparent and obvious to one of ordinary skill in the art. The present invention encompasses all equivalent relationships to those illustrated in the drawings and described in the specification. The novel spirit of the present invention is still embodied by reordering or deleting some of the steps contained in this disclosure. The spirit of the invention is not meant to be limited in any way except by proper construction of the following claims.

1. A method for organizing a plurality of icons on a computer desktop comprising:
classifying the icons into an icon group;
placing the icon group into a segment; and
organizing the icons within the segment.

2. The method of claim 1 further comprising:
analyzing the icons to determine the icons' attributes; and
using the icons' attributes to classify the icons.

3. The method of claim 2 wherein the icons' attributes are a type of application associated with each of the icons.

4. The method of claim 1 wherein the organization of the icons is to shrink the icons down to the icons' smallest possible size.

5. The method of claim 1 wherein the organization of the icons is to change the size of the icons such that the icons fill the segment.

6. The method of claim 1 wherein the organization of the icons is to place the icons in the segment at normal size, but if the icons do not fit into the segment at normal size, then to shrink the size of the icons until the icons fit into the segment.

7. The method of claim 1 wherein the organization of the icons is to place the icons in the segment at normal size, but if the icons do not fit into the segment at normal size, then to add a scroll bar within the segment.

8. The method of claim 1 wherein the segment is defined by steps comprising:
defining a segment location;
defining a segment size;
defining the icon group associated with the segment;
defining the icons organization within the segment; and
defining whether the segment covers the wallpaper on the desktop.

9. The method of claim 1 wherein the segment does not cover the wallpaper on the desktop.

10. The method of claim 1 wherein the segment is user defined.

11. The method of claim 1 wherein the icon group is a group of webpages.

12. The method of claim 1 wherein the icon group is a group of games.

13. The method of claim 1 wherein the icon group is a group of development tools.

14. A method comprising:
analyzing a plurality of icons to determine the icons' attributes;
classifying the icons into an icon group using the icons' attributes;
placing the icon group into a segment;
organizing the icons within the segment; and
wherein the segment does not cover the wallpaper on the desktop.

15. The method of claim 14 wherein the segment is defined by steps comprising:
defining a segment location;
defining a segment size;
defining the icon group associated with the segment;
defining the icons organization within the segment; and
defining whether the segment covers the wallpaper on the desktop.

16. The method of claim 15 wherein the icons' attributes are a type of application associated with each of the icons.

17. The method of claim 15 wherein the organization of the icons is to shrink the icons down to the icons' smallest possible size.

18. The method of claim 15 wherein the organization of the icons is to change the size of the icons such that the icons fill the segment.

19. The method of claim 15 wherein the organization of the icons is to place the icons in the segment at normal size, but if the icons do not fit into the segment at normal size, then to shrink the size of the icons until the icons fit into the segment.

20. The method of claim 15 wherein the organization of the icons is to place the icons in the segment at normal size, but if the icons do not fit into the segment at normal size, then to add a scroll bar within the segment.

21. The method of claim 15 wherein the segment is user defined.

22. The method of claim 15 wherein the icon group is a group of webpages.

23. The method of claim 15 wherein the icon group is a group of games.

24. The method of claim 15 wherein the icon group is a group of development tools.

25. A program product operable on a computer comprising:
a computer-usable medium;
wherein the computer usable medium comprises instructions for a computer to perform steps comprising:
instructions for classifying a plurality of icons into an icon group;
instructions for placing the icon group into a segment; and
instructions for organizing the icons within the segment.

26. The program product of claim 25 further comprising:
instructions for analyzing the icons to determine the icons' attributes; and
instructions for using the icons' attributes to classify the icons.

27. The program product of claim 26 wherein the icons' attributes are a type of application associated with each of the icons.

28. The program product of claim 25 wherein the organization of the icons is to shrink the icons down to the icons' smallest possible size.

29. The program product of claim 25 wherein the organization of the icons is to change the size of the icons such that the icons fill the segment.

30. The program product of claim 25 wherein the organization of the icons is to place the icons in the segment at normal size, but if the icons do not fit into the segment at normal size, then to shrink the size of the icons until the icons fit into the segment.

31. The program product of claim 25 wherein the organization of the icons is to place the icons in the segment at normal size, but if the icons do not fit into the segment at normal size, then to add a scroll bar within the segment.

32. The program product of claim 25 wherein the segment is defined by steps comprising:
instructions for defining a segment location;
instructions for defining a segment size;
instructions for defining the icon group associated with the segment;
instructions for defining the icons organization within the segment; and
instructions for defining whether the segment covers the wallpaper on the desktop.

33. The program product of claim 25 wherein the segment does not cover the wallpaper on the desktop.

34. The program product of claim 25 wherein the segment is user defined.

35. The program product of claim 25 wherein the icon group is a group of webpages.

36. The program product of claim 25 wherein the icon group is a group of games.

37. The program product of claim 25 wherein the icon group is a group of development tools.

38. A program product operable on a computer comprising:
a computer-usable medium;
wherein the computer usable medium comprises instructions for a computer to perform steps comprising:
instructions for analyzing a plurality of icons to determine the icons' attributes;
instructions for classifying the icons into an icon group using the icons' attributes;
instructions for placing the icon group into a segment;
instructions for organizing the icons within the segment; and
wherein the segment does not cover the wallpaper on the desktop.

39. The program product of claim 38 wherein the segment is defined by steps comprising:
instructions for defining a segment location;
instructions for defining a segment size;
instructions for defining the icon group associated with the segment;
instructions for defining the icons organization within the segment; and
instructions for defining whether the segment covers the wallpaper on the desktop.

40. The program product of claim 38 wherein the icons' attributes are a type of application associated with each of the icons.

41. The program product of claim 38 wherein the organization of the icons is to shrink the icons down to the icons' smallest possible size.

42. The program product of claim 38 wherein the organization of the icons is to change the size of the icons such that the icons fill the segment.

43. The program product of claim 38 wherein the organization of the icons is to place the icons in the segment at normal size, but if the icons do not fit into the segment at normal size, then to shrink the size of the icons until the icons fit into the segment.

44. The program product of claim 38 wherein the organization of the icons is to place the icons in the segment at normal size, but if the icons do not fit into the segment at normal size, then to add a scroll bar within the segment.

45. The program product of claim 38 wherein the segment is user defined.

46. The program product of claim 38 wherein the icon group is a group of webpages.

47. The program product of claim 38 wherein the icon group is a group of games.

48. The program product of claim 38 wherein the icon group is a group of development tools.
